(19) United States
(12) Patent Application Publication
(10) Pub. No.: US 2003/0047606 A1
(43) Pub. Date: Mar. 13, 2003

(54) Computer system having a smart card reader

(76) Inventors: David J. Kim, San Jose, CA (US); Dimitry Struve, Los Altos, CA (US); William W. Ruckman, San Jose, CA (US)

Correspondence Address: WILLIAMS, MORGAN & AMERSON, P.C., 10333 RICHMOND, SUITE 1100, HOUSTON, TX, 77042, US

(21) Appl. No.: 09/951,281

(22) Filed: Sep. 13, 2001

(51) Int. Cl. G06K 7/06

(52) U.S. Cl. 235/441

(57) ABSTRACT

A smart card reader assembly includes a printed circuit board having a bus, a smart card reader interconnected with the bus of the printed circuit board, and a connector interconnected with the bus of the printed circuit board. The smart card reader is capable of reading data from a smart card and is capable of transmitting signals representing the data to the bus of the printed circuit board. Further, the smart card reader assembly is capable of being oriented so that the smart card may be inserted into the smart card reader in an upright orientation.

### BACKGROUND OF THE INVENTION

1. Fielf of the Invention

This invention relates to a computer system having a smart card reader. In one aspect, the invention relates to a method for using the smart card reader in the computer system and a method for producing the computer system having the smart card reader.

2. Description of the Related Art

Computer systems are general-purpose devices that may be modified to perform particular tasks or functions. Generally, computer systems include a motherboard, a power source, and other components mounted within an enclosure. Many computer systems are used by various users and/or may be used in areas to which access is uncontrolled or is difficult to control. In situations such as these, it may be desirable to require that a potential computer system user be identified prior to the user accessing the computer system. One way of identifying the user is to provide the user an integrated circuit card (e.g., a “smart card,” or the like) and to equip the computer system with an integrated circuit card reader (e.g., a “smart card reader,” or the like).

Generally, the smart card may be a credit card-sized plastic card having an embedded computer chip therein. The chip can be either a microprocessor with internal memory or a memory chip having non-programmable logic. Information relating to the user can be stored as data within the chip. In use, the smart card may be inserted into the smart card reader and a direct electrical connection may be made between the smart card reader and the chip via contact points on the smart card. The data (or a portion of the data) stored in the chip may then be transmitted by the smart card to the computer system for processing, access to the computer system, and the like.

Many conventional smart card readers are configured to fit within a dimensional envelope of a floppy disk drive and are installed in computer systems in the same fashion as conventional floppy disk drives. However, such installations may take up space within an enclosure housing the computer system that could otherwise be used for a floppy disk drive, a hard disk drive, a tape drive, or the like.

### SUMMARY OF THE INVENTION

In one aspect of the present invention, a smart card reader assembly is to provided. The smart card reader assembly includes a printed circuit board having a bus, a smart card reader interconnected with the bus of the printed circuit board, and a connector interconnected with the bus of the printed circuit board. The smart card reader is capable of reading data from a smart card and is capable of transmitting signals representing the data to the bus of the printed circuit board. Further, the smart card reader assembly is capable of being oriented so that the smart card may be inserted into the smart card reader in an upright orientation.

In another aspect of the present invention, a computer system is provided. The computer system includes an enclosure and a smart card reader assembly disposed within the enclosure. The smart card reader assembly includes a printed circuit board having a bus and mounted within the enclosure and a smart card reader interconnected with the bus of the printed circuit board. The smart card reader is capable of reading data from a smart card and transmitting first signals representing the data to the bus of the printed circuit board. Further, the smart card reader assembly is capable of being oriented so that the smart card may be inserted into the smart card reader in an upright orientation.

In yet another aspect of the present invention, a method is provided including inserting a smart card in an upright orientation into a smart card reader, reading data from the smart card into the smart card reader, and transmitting signals corresponding to the data to a computer system.

In a further aspect of the present invention, a method is provided including providing a smart card reader assembly having a smart card reader, providing an enclosure, and locating the smart card reader within the enclosure such that a smart card may be inserted into the smart card reader in an upright orientation from outside the enclosure.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a partially-exploded perspective view of a computer system according to the present invention having a wall mounted smart card reader;

FIG. 2 is a partial perspective view of a portion of the computer system of FIG. 1;

FIG. 3 is a stylized diagram of portions of the computer system according to the present invention;

FIG. 4 is a flowchart of a method according to the present invention; and

FIG. 5 is a flowchart of a method according to the present invention.

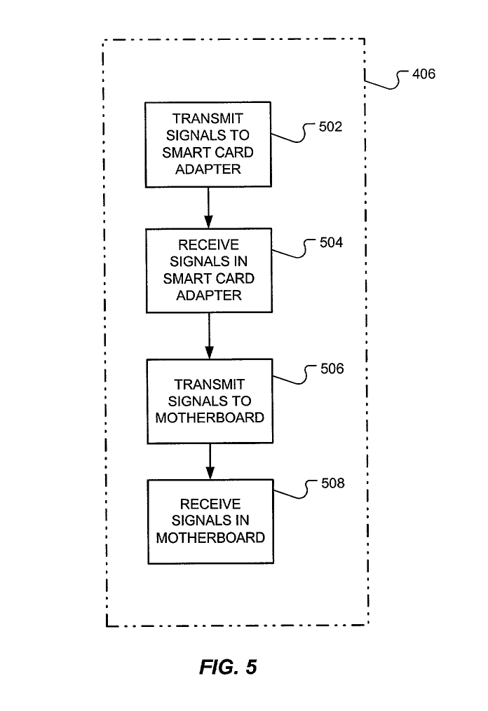

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

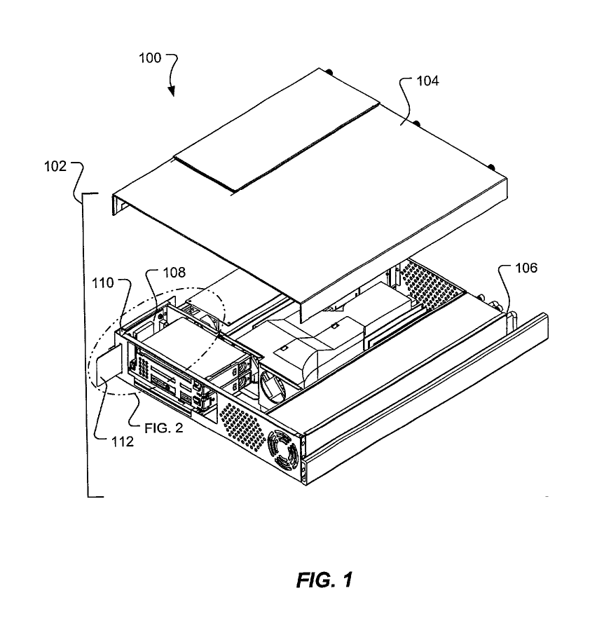

As illustrated in FIG. 1, a computer system 100 includes an enclosure 102 having a cover 104 and a base 106. The cover 104 is attachable to the base 106 to cover various components housed within the enclosure 102. The computer system 100 further includes a smart card reader assembly 108 attached within an interior of the base 106 to a first wall 110 of the base 106. Generally, the smart card reader assembly 108 is a device that is capable of reading data from a smart card 112 and transmitting the data as electrical signals, optical signals, or the like to a component of the computer system 100 for use by the computer system 100.

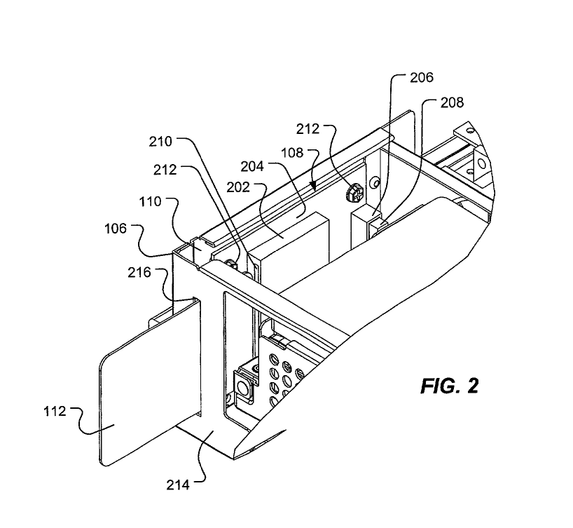

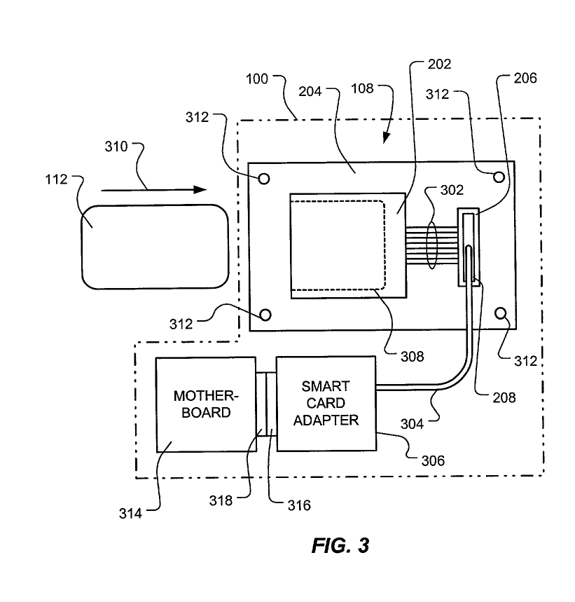

Referring now to FIGS. 2 and 3, the smart card reader assembly 108 includes a smart card reader 202, a printed circuit board 204 having a bus 302 extending to the smart card reader 202 and extending to a connector 206. A cable 304 extends between a connector 208, which may be mated with the connector 206 of the smart card reader assembly 108, and a smart card adapter 306 of the computer system 100. It is within the scope of the present invention, however, for the smart card reader assembly 108 to omit the connector 206 and for the smart card adapter 306 to be directly connected to the bus 302 of the printed circuit board 204.

The smart card reader 202 has a slot 210 therein that is sized to allow the smart card 112 to be inserted into a cavity 308 in the smart card reader 202. Thus, when the smart card 112 is inserted (as indicated by an arrow 310) through the slot 210 and into the cavity 308 of the smart card reader 202, data may be read from the smart card 112 by the smart card reader 202 and may be transmitted as electrical signals, optical signals, or the like, via the bus 302 of the printed circuit board 204, the mated connectors 206, 208, and the cable 304 to the smart card adapter 306. Generally, the smart card adapter 306 is a device capable of receiving such signals from the smart card reader assembly 108 and transmitting them to a motherboard 314. In the illustrated embodiment, the smart card adapter 306 is interconnected to the motherboard 314 via the mated connectors 316, 318.

The printed circuit board 204 is attached within the interior of the base 106 to the first wall 110 of the base 106 by one or more fasteners, e.g., screws, nuts and bolts, rivets, clips, Christmas-tree fasteners, adhesives, hook-and-loop fasteners, or the like. In one embodiment, the printed circuit board 204 is attached by four screws 212 (only two shown) through corresponding openings 312 in the printed circuit board 204, to the first wall 110 of the base 106. While the illustrated embodiment provides for the printed circuit board 204 to be attached to the first wall 110 of the base 106, the scope of the present invention encompasses the printed circuit board 204 being mounted such that it is generally parallel to the first wall 110 of the base 106. For example, in one embodiment, the smart card reader assembly 108 may be attached to a bracket (not shown) attached to the base 106.

A second wall 214 of the base 106 has an opening 216 therethrough, generally aligned with the slot 210 of the smart card reader 202, that is sized to allow the smart card 112 to be inserted therethrough and through the slot 210 of the smart card reader 202 into the smart card reader 202.

In addition to the configuration illustrated in FIGS. 1-3, the scope of the present invention also encompasses a smart card reader assembly (e.g., the smart card reader assembly 108) that may be installed into a computer system (e.g., the computer system 100) such that a smart card (e.g., the smart card 112) may be presented to the smart card reader assembly 108 in an upright orientation, as illustrated in FIGS. 1-3.

Further, referring to FIGS. 1-4, a method according to the present invention comprises inserting the smart card 112 (block 402) in an upright orientation (as illustrated in FIGS. 1-3) into the smart card reader 202, reading data from the smart card 112 into the smart card reader 202 (block 404), and transmitting signals corresponding to the data read from the smart card 112 to the computer system 100 (block 406). In one embodiment, transmitting the signals corresponding to the data read from the smart card 112 to the computer system 100 (block 406) further includes transmitting first signals from the smart card reader 202 to the smart card adapter 306 (block 502) and receiving the first signals in the smart card adapter 306 (block 504). Further, the method includes transmitting second signals, corresponding to the first signals, from the smart card adapter 306 to the motherboard 314 (block 506) and receiving the second signals in the motherboard 314 (block 508).

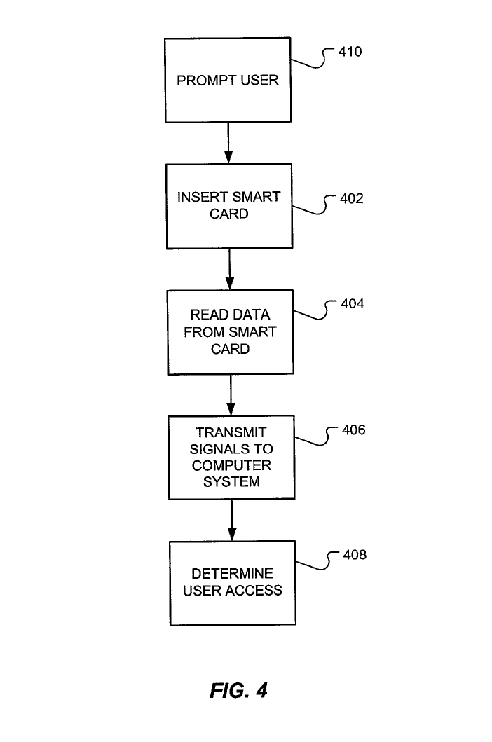

Referring again to FIG. 4, another embodiment of the present invention further includes determining access of a user to the computer system 100 based upon the signals transmitted to the computer system 100 (block 408). In a further embodiment, the method includes prompting the user to insert the smart card 112 into the computer system 100 (block 410) and determining access of the user to the computer system 100 based upon the signals transmitted to the computer system 100 (block 408). The prompts may be displayed by a display device, such as a cathode ray tube, a liquid crystal device, or the like.

According to another embodiment of the present invention, a method includes providing the smart card reader assembly 108 having the smart card reader 202, providing the enclosure 102, and locating the smart card reader 202 within the enclosure 102 such that the smart card 112 may be inserted into the smart card reader 202 in an upright orientation (as illustrated in FIGS. 1-3) from outside the enclosure 102. In one embodiment, the method further includes mounting the smart card reader assembly 108 to an upstanding wall (e.g., the wall 110, or the like) of the enclosure 102. In another embodiment, the method includes mounting the smart card reader assembly 108 to a bracket (not shown) within the enclosure 102.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed is:

1. A smart card reader assembly, comprising:
a printed circuit board having a bus;
a smart card reader interconnected with the bus of the printed circuit board, wherein the smart card reader is capable of reading data from a smart card and is capable of transmitting signals representing the data to the bus of the printed circuit board; and
a connector interconnected with the bus of the printed circuit board, wherein the smart card reader assembly is capable of being oriented so that the smart card may be inserted into the smart card reader in an upright orientation.

2. A smart card reader assembly, according to claim 1, wherein the printed circuit board further comprises an opening adapted to receive a fastener for mounting the printed circuit board to a member.

3. A smart card reader assembly, according to claim 1, wherein the printed circuit board further comprises an opening adapted to receive a fastener for mounting the printed circuit board to a member selected from the group consisting of a screw, a nut and bolt, a rivet, a clip, and a Christmas-tree fastener.

4. A computer system, comprising:
an enclosure; and
a smart card reader assembly disposed within the enclosure, comprising:
a printed circuit board having a bus and mounted within the enclosure; and
a smart card reader interconnected with the bus of the printed circuit board, wherein the smart card reader is capable of reading data from a smart card and transmitting first signals representing the data to the bus of the printed circuit board,
wherein the smart card reader assembly is capable of being oriented so that the smart card may be inserted into the smart card reader in an upright orientation.

5. A computer system, according to claim 4, wherein the printed circuit board further comprises at least one opening adapted to receive a fastener for mounting the printed circuit board to the enclosure.

6. A computer system, according to claim 4, wherein the printed circuit board further comprises an opening and wherein the computer system further comprises a fastener, disposed through the opening in the printed circuit board and engaged with the enclosure, for mounting the smart card reader assembly to the enclosure.

7. A computer system, according to claim 6, wherein the fastener is selected from the group consisting of a screw, a nut and bolt, a rivet, a clip, and a Christmas-tree fastener.

8. A computer system, according to claim 4, further comprising a fastener for mounting the smart card reader assembly to the enclosure.

9. A computer system, according to claim 8, wherein the fastener is selected from the group consisting of an adhesive and a hook-and-loop fastener.

10. A computer system, according to claim 4, wherein the enclosure further comprises a wall to which the smart card assembly is mounted.

11. A computer system, according to claim 4, wherein the enclosure further comprises a bracket within the enclosure to which the smart card assembly is mounted.

12. A computer system, according to claim 4, wherein the smart card reader further comprises a slot therein and wherein the enclosure further comprises a wall having an opening therethrough, generally aligned with the slot in the smart card reader and sized to allow the smart card to be inserted therethrough and into the slot of the smart card reader so that the smart card reader may read data from the smart card.

13. A computer system, according to claim 4, further comprising:
a smart card adapter interconnected with the bus of the printed circuit board, capable of receiving the first signals from the bus of the printed circuit board, and capable of transmitting second signals corresponding to the first signals; and
a motherboard interconnected with the smart card adapter and capable of receiving the second signals from the smart card adapter.

14. A computer system, according to claim 4, wherein the smart card reader assembly further comprises a connector interconnected with the bus of the printed circuit board and wherein the computer system further comprises:
a smart card adapter;
a cable interconnecting the connector of the printed circuit board and the smart card adapter capable of transmitting the first signals from the bus of the printed circuit board to the smart card adapter; and
a motherboard interconnected with the smart card adapter,
wherein the smart card adapter is capable of receiving the first signals from the cable and is capable of transmitting second signals, corresponding to the first signals, to the motherboard.

15. A method, comprising:
inserting a smart card in an upright orientation into a smart card reader;
reading data from the smart card into the smart card reader;
transmitting signals corresponding to the data to a computer system.

16. A method, according to claim 15, wherein transmitting the signals corresponding to the data to the computer system further comprises:
transmitting first signals from the smart card reader to a smart card adapter;
receiving the first signals in the smart card adapter;
transmitting second signals, corresponding to the first signals, from the smart card adapter to a motherboard; and
receiving the second signals in the motherboard.

17. A method, according to claim 15, further comprising determining access of a user to the computer system based upon the signals transmitted to the computer system.

18. A method, according to claim 15, further comprising:
prompting a user to insert the smart card into the computer system; and
determining access of the user to the computer system based upon the signals transmitted to the computer system.

19. A method, comprising:
providing a smart card reader assembly having a smart card reader;
providing an enclosure; and
locating the smart card reader within the enclosure such that a smart card may be inserted into the smart card reader in an upright orientation from outside the enclosure.

20. A method, according to claim 19, wherein locating the smart card reader within the enclosure further comprises mounting the smart card reader assembly to an upstanding wall of the enclosure.

21. A method, according to claim 19, wherein locating the smart card reader within the enclosure further comprises mounting the smart card reader assembly to a bracket within the enclosure.

22. An apparatus, comprising:
inserting a smart card in an upright orientation into a smart card reader;
reading data from the smart card into the smart card reader;
transmitting signals corresponding to the data to a computer system.

23. An apparatus, according to claim 22, wherein transmitting the signals corresponding to the data to the computer system further comprises:
transmitting first signals from the smart card reader to a smart card adapter;
receiving the first signals in the smart card adapter;
transmitting second signals, corresponding to the first signals, from the smart card adapter to a motherboard; and
receiving the second signals in the motherboard.

24. An apparatus, according to claim 22, further comprising determining access of a user to the computer system based upon the signals transmitted to the computer system.

25. An apparatus, according to claim 22, further comprising:
prompting a user to insert the smart card into the computer system; and
determining access of the user to the computer system based upon the signals transmitted to the computer system.

26. An apparatus, comprising:
providing a smart card reader;
providing an enclosure; and
locating the smart card reader within the enclosure such that a smart card may be inserted into the smart card reader in an upright orientation from outside the enclosure.

27. An apparatus, according to claim 26, wherein locating the smart card reader within the enclosure further comprises mounting the smart card reader to an upstanding wall of the enclosure.

28. An apparatus, according to claim 26, wherein locating the smart card reader within the enclosure further comprises mounting the smart card reader to a bracket within the enclosure.
